(19) United States
(12) Patent Application Publication
(10) Pub. No.: US 2025/0324162 A1
(43) Pub. Date: Oct. 16, 2025

(54) PHOTOGRAPHING CONTROL

(71) Applicant: TENCENT TECHNOLOGY (SHENZHEN) COMPANY LIMITED, Shenzhen (CN)

(72) Inventors: Zheming HONG, Shenzhen (CN); Shaoming WANG; Runzeng GUO, Shenzhen (CN); Jinkun HOU, Shenzhen (CN); Jun WANG, Shenzhen (CN)

(73) Assignee: TENCENT TECHNOLOGY (SHENZHEN) COMPANY LIMITED, Shenzhen, GD (CN)

(21) Appl. No.: 19/248,354

(22) Filed: Jun. 24, 2025

Related U.S. Application Data
(63) Continuation of application No. PCT/CN2024/095135, filed on May 24, 2024.

(30) Foreign Application Priority Data
Jul. 17, 2023 (CN) 202310884155.5

(51) Int. Cl. H04N 23/72; G06V 10/98; G06V 40/20; H04N 23/611; H04N 23/667; H04N 23/73; H04N 23/74

(52) U.S. Cl. CPC H04N 23/72; G06V 10/993; H04N 23/611; H04N 23/667; H04N 23/73; H04N 23/74; G06V 40/28

(57) ABSTRACT

Aspects of the disclosure provide a method of photographing control. For example, according to an image collection instruction, a lamp is set to an illumination mode. The lamp provides a supplemental light with a supplementation intensity exceeding a preset intensity threshold in the illumination mode. A photographing mode of a camera is adjusted from a fixed exposure mode to an automatic exposure mode. The automatic exposure mode uses a fixed exposure parameter value of the fixed exposure mode as an initial exposure parameter value. M shot images are taken by the camera based on the automatic exposure mode with the initial exposure parameter value. M is an integer greater than or equal to 1. A target shot image is determined from the M shot images. The target shot image has an image quality satisfying a preset image quality requirement. Apparatus and non-transitory computer-readable storage medium counterpart embodiments are also contemplated.

### RELATED APPLICATIONS

The present application is a continuation of International Application No. PCT/CN2024/095135, filed on May 24, 2024, which claims priority to Chinese Patent Application No. 202310884155.5, filed on Jul. 17, 2023. The entire disclosures of the prior applications are hereby incorporated by reference.

### FIELD OF THE TECHNOLOGY

This application relates to the technical field Internet, including a photographing control technology.

### BACKGROUND OF THE DISCLOSURE

In a payment scenario, payment methods can include face swiping payment and code scanning payment. In other words, face recognition and verification are performed after facial features are collected by a face swiping device, or payment codes are verified by a code scanning device.

Similar to a face, a fingerprint, and an iris, prints and veins of a palm have unique biometric recognition features. This provides theoretical support for palm swiping payment. Different from fingerprint recognition that reads a skin texture of a finger pulp, palmprint recognition is to read a palm blood vessel texture that is more difficult to forge. Thus, payment security can be better ensured. The palm swiping payment is a desirable way to keep balance between personal privacy protection and rapid and convenient payment, and thus has a promising development prospect.

In a scenario of the palm swiping payment, to enable the palm to be clearly imaged, a focal plane of a camera needs to be controlled to be basically located on the palm. Moreover, for ease of palm swiping, the focal plane of the camera of a palm swiping device is generally set to be parallel to a ceiling. However, when stretched out for swiping, the palm blocks original light. With environmental light changed significantly, it is unlikely to collect a clear palmprint image, and consequently, a palm swiping failure is caused.

### SUMMARY

Embodiments of this disclosure provide a photographing control method and a related apparatus, so as to solve a problem of low image definition caused by environmental light in the related art.

Some aspects of the disclosure provide a method of photographing control. For example, according to an image collection instruction, a lamp is set to an illumination mode, the lamp provides a supplemental light with a supplementation intensity exceeding a preset intensity threshold in the illumination mode. A photographing mode of a camera is adjusted from a fixed exposure mode to an automatic exposure mode. The automatic exposure mode uses a fixed exposure parameter value of the fixed exposure mode as an initial exposure parameter value. M shot images are taken by the camera based on the automatic exposure mode with the initial exposure parameter value. M is an integer greater than or equal to 1. A target shot image is determined from the M shot images. The target shot image has an image quality satisfying a preset image quality requirement.

Some aspects of the disclosure provide an apparatus that includes processing circuitry. In some examples, according to an image collection instruction, the processing circuitry sets a lamp to an illumination mode. The lamp is configured to provide a supplemental light with a supplementation intensity exceeding a preset intensity threshold in the illumination mode. The processing circuitry adjusts a photographing mode of a camera from a fixed exposure mode to an automatic exposure mode. The automatic exposure mode uses a fixed exposure parameter value of the fixed exposure mode as an initial exposure parameter value. The processing circuitry takes M shot images by the camera based on the automatic exposure mode with the initial exposure parameter value. M is an integer greater than or equal to 1. The processing circuitry can determine a target shot image from the M shot images. The target shot image has an image quality satisfying a preset image quality requirement.

Some aspects of the disclosure provide a non-transitory computer-readable storage medium storing instructions which when executed by at least one processor cause the at least one processor to perform the method of photographing control.

In an aspect, this disclosure provides a photographing control method. The photographing control method is performed by an image collection device, and the image collection device includes a camera and a lamp. The photographing control method includes making a response to an image collection instruction, and activating an illumination mode, the illumination mode being configured for indicating that the lamp is in a high-brightness state, and in the high-brightness state, a light supplementation intensity of the lamp exceeding a preset intensity threshold. The method also includes adjusting a photographing mode to an automatic exposure mode; collecting an image based on the automatic exposure mode by controlling the camera, and obtaining M shot images, M being an integer greater than or equal to 1; and determining a target shot image from the M shot images, the target shot image being a shot image having an image quality satisfying a preset image quality requirement.

In another aspect, this disclosure provides a photographing control apparatus. The photographing control apparatus includes: an image collection instruction response module, an automatic exposure mode adjustment module, a photographing module, and a target shot image determination module. Specifically, the image collection instruction response module is configured to make a response to an image collection instruction and activate an illumination mode, the illumination mode being configured for indicating that a lamp is in a high-brightness state, and in the high-brightness state, a light supplementation intensity of the lamp exceeding a preset intensity threshold. The automatic exposure mode adjustment module is configured to adjust a photographing mode to an automatic exposure mode. The photographing module is configured to collect an image based on the automatic exposure mode by controlling the camera, and obtain M shot images, M being an integer greater than or equal to 1. The target shot image determination module is configured to determine a target shot image from the M shot images, the target shot image being a shot image having an image quality satisfying a preset image quality requirement.

In yet another aspect, this disclosure provides a computer device. The computer device includes: a memory, a transceiver, a processor, and a bus system. The memory is configured to store a program. The processor (an example of processing circuitry) is configured to execute the program in the memory, and performing the method in each aspect above. The bus system is configured to connect the memory to the processor, so as to enable the memory to communicate with the processor.

In yet another aspect, this disclosure provides a computer-readable storage medium (e.g., non-transitory computer-readable storage medium). The computer-readable storage medium stores instructions, the instructions, when run on a computer, causing the computer to perform the method in each aspect above.

In still another aspect, this disclosure provides a computer program product or a computer program. The computer program product or the computer program includes computer instructions, the computer instructions being stored in a computer-readable storage medium. A processor of a computer device reads the computer instructions from the computer-readable storage medium, and the processor executes the computer instructions, so as to enable the computer device to perform the method provided in each aspect above.

It can be seen from the above technical solution that the embodiments of this disclosure have the advantages. For example, this disclosure provides the photographing control method and the related apparatus. The method is applied to the image collection device, and the image collection device includes the camera and the lamp. The method includes: making a response to the image collection instruction, and setting the operating mode of the lamp to the illumination mode, the illumination mode being configured for indicating that the lamp is in the high-brightness state, and in the high-brightness state, the light supplementation intensity of the lamp exceeding the preset intensity threshold; adjusting the photographing mode to the automatic exposure mode; collecting the image based on the automatic exposure mode by controlling the camera, and obtaining the M shot images, M being the integer greater than or equal to 1; and determining the target shot image from the M shot images, the target shot image being the shot image having the image quality satisfying the preset image quality requirement. This disclosure provides the photographing control method. The lamp is set to the illumination mode, so as to illuminate a target object when making a response to the image collection instruction, and thus the target object can be clearly imaged under sufficient light. After the target object is illuminated, a fixed exposure mode is adjusted to the automatic exposure mode for photographing the target object, so that the image collected from the target object can be clear, and a success rate of verifying the target object can be increased.

### BRIEF DESCRIPTION OF THE DRAWINGS

FIG. 1 is a schematic diagram of an architecture of a photographing control system according to an embodiment of this disclosure;

FIG. 2 is a diagram of an application environment of a photographing control method in a palm swiping scenario according to an embodiment of this disclosure;

FIG. 3 is a flowchart of a photographing control method according to an embodiment of this disclosure;

FIG. 4 is a flowchart of a photographing control method according to another embodiment of this disclosure;

FIG. 5 is a flowchart of a photographing control method according to yet another embodiment of this disclosure;

FIG. 6 is a flowchart of a photographing control method according to yet another embodiment of this disclosure;

FIG. 7 is a flowchart of a photographing control method according to yet another embodiment of this disclosure;

FIG. 8 is a flowchart of a photographing control method according to yet another embodiment of this disclosure;

FIG. 9 is a flowchart of a photographing control method according to yet another embodiment of this disclosure;

FIG. 10 is a flowchart of a photographing control method according to yet another embodiment of this disclosure;

FIG. 11 is a flowchart of a photographing control method according to yet another embodiment of this disclosure;

FIG. 12 is a flowchart of a photographing control method according to yet another embodiment of this disclosure;

FIG. 13 is a flowchart of a photographing control method according to still another embodiment of this disclosure;

FIG. 14 is a flowchart of a photographing control method applied to a palm swiping scenario according to an embodiment of this disclosure;

FIG. 15 is a sequence diagram of exposure in photographing control according to an embodiment of this disclosure;

FIG. 16 is a schematic structural diagram of a photographing control apparatus according to an embodiment of this disclosure;

FIG. 17 is a schematic structural diagram of a photographing control apparatus according to another embodiment of this disclosure;

FIG. 18 is a schematic structural diagram of a photographing control apparatus according to yet another embodiment of this disclosure;

FIG. 19 is a schematic structural diagram of a photographing control apparatus according to yet another embodiment of this disclosure;

FIG. 20 is a schematic structural diagram of a photographing control apparatus according to still another embodiment of this disclosure; and

FIG. 21 is a schematic structural diagram of a server according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

The terms such as “first”, “second”, “third”, and “fourth” (if any) in the description and claims of this disclosure and in the above accompanying drawings are used for distinguishing between similar objects and are not necessarily used for describing a particular order or successive sequence. Data used in this way are exchangeable in a proper case, so that embodiments of this disclosure described herein can be implemented in an order different from those shown or described herein. In addition, the terms “comprise”, “include”, “correspond to” and their any variants are intended to cover the non-exclusive inclusion. For example, a process, method, system, product, or device that encompasses a series of steps or units is not necessarily limited to those steps or units expressly listed, but can include other steps or units not expressly listed or inherent to such a process, method, product, or device.

For ease of understanding the technical solution according to the embodiments of this disclosure, some key terms used in the embodiments of this disclosure are first explained herein:

Palm area detection refers to, in some examples of the present disclosure, a target detection technology that locates finger gap points in a picture, and extracts a palm area image from the picture.

Palmprint recognition refers to, in some examples of the present disclosure, recognizing identity information of a user according to the palm area image of the user.

Cross-device registration and recognition refers to, in some examples of the present disclosure, registration and recognition that are separately performed on two devices that are significantly different from each other. For example, the registration is performed on a mobile phone, and the recognition is performed through an Internet of Things device.

Color image refers to, in some examples of the present disclosure, a color image that is formed under natural light, is collected by a color sensor, and is used for: face/palm preference and comparative recognition during face/palm swiping payment.

Infrared image refers to, in some examples of the present disclosure, an infrared image that is formed under infrared light, is collected by an infrared sensor, and is for: living body detection during face/palm swiping payment.

Preferably selection refers to, in some examples of the present disclosure, a selection of a set of a color image, a depth image, and an infrared image that satisfy preconditions of the living body detection and a comparative recognition algorithm (e.g., the color image, the depth image, and the infrared image are needed for face swiping payment, and the color image and the infrared image are needed for palm swiping payment). During specific preference, the color image can be performed according to a face/palm angle, size, centralization degree, and definition of the color image; the infrared image can be preferred according to brightness of the infrared image; and the depth image can be preferred according to a completeness degree of (face swiping) of the depth image.

Preferred payment frame refers to, in some examples of the present disclosure, one set of the color image, the depth image, and the infrared image that satisfy the preference (e.g., the color image, the depth image, and the infrared image are needed for the face swiping payment, and the color image and the infrared image are needed for the palm swiping payment) can be configured for the living body detection and the comparative recognition.

Automatic exposure (AE) refers to, in some examples of the present disclosure, a process that automatically adjusts an exposure amount according to a light intensity, so as to prevent an overexposure or an underexposure.

Compared with the face swiping payment, the palm swiping payment is to collect a palmprint, so that psychological pressure of people on facial sensitive parts can be greatly reduced, requirements on personal privacy can be lowered, and stability can be improved. Compared with code scanning payment, the palm swiping payment can greatly simplify a payment process, so that the user can obtain feeling-free payment experience, and moreover, the user can make the payment conveniently and quickly. The palm swiping payment can achieve natural, feeling-free, and ergonomic interaction. The collection of non-sensitive biological information can reduce psychological burden and privacy concern of the user and is more acceptable, so as to replace two-dimensional code payment in the field of retailing and provide rapid payment experience in a micropayment scenario. The palming swiping payment can support rapid passage of a smart gate in the field of public transportation and can also provide the user with convenient use experience in office scenarios involving access control recognition and check-in in a private region.

In a palm swiping scenario, to enable a palm to be clearly imaged, a focal plane of a camera needs to be controlled to be basically located on the palm. Moreover, for ease of palm swiping, the focal plane of the camera of a palm swiping device is generally set to be parallel to a ceiling. However, when stretched out for swiping, the palm blocks original light. With environmental light changed significantly, it is unlikely to collect a clear palmprint image, and consequently, a palm swiping failure is caused.

In the related art, an exposure mode is mainly divided into two types. One is automatic exposure. An automatic exposure time is long and generally 200 ms to 400 ms. If a palm swiping process completely depends on the automatic exposure, the user cannot be provided with desirable palm swiping experience due to the long exposure time. The other one is fixed exposure. Compared with the automatic exposure, although an exposure adjustment time is omitted in the fixed exposure, so as to improve an exposure speed, a few ranges and light scenarios are adapted to the fixed exposure. In an indoor scenario, when a distance between the palm and a palm swiping terminal is within 6 CM to 9 CM, desirable palm swiping experience can be achieved, but the fixed exposure cannot adapt to a full range of 3 CM to 12 CM defined by the palm swiping terminal or a scenario with outdoor light changed.

This disclosure provides a photographing control method. A response to an image collection instruction is made, a lamp is set to an illumination mode, so as to illuminate a palm, and thus the palm can be clearly imaged under sufficient light. After the palm is illuminated, fixed exposure is adjusted to automatic exposure for photographing, so that a clear palm image is collected, and a success rate of palm swiping is increased.

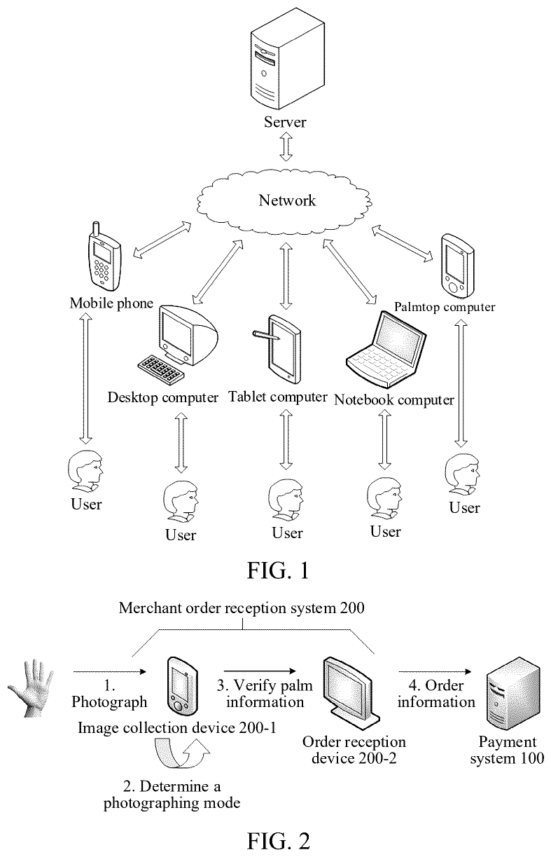

For ease of understanding, with reference to FIG. 1, a photographing control system in an embodiment of this disclosure is shown. As shown in FIG. 1, the photographing control system in the embodiment of this disclosure includes: a server and a terminal device. The server may be a stand-alone physical server, a server cluster or distributed system composed of a plurality of physical servers, or a cloud server that provides basic cloud computation services such as a cloud service, a cloud database, cloud computation, a cloud function, cloud storage, a network service, cloud communication, a middleware service, a domain name service, a security service, a content delivery network (CDN), big data, and an artificial intelligence platform. The terminal may be, but is not limited to, a smart phone, a tablet computer, a notebook computer, a desktop computer, a smart speaker, a smart watch, etc. The server is configured to verify a target object in a target shot image. The terminal device is an image collection device and is configured to collect an image from the target object. The terminal device may be directly or indirectly connected to the server in a wired or wireless communication mode, which is not limited in the embodiments of this disclosure.

The image collection device first makes a response to an image collection instruction and sets an operating mode of a lamp to an illumination mode, the illumination mode being configured for indicating that the lamp is in a high-brightness state, and in the high-brightness state, brightness of the lamp exceeding a preset brightness threshold. Next, the image collection device adjusts a photographing mode of a camera to an automatic exposure mode. Then, the image collection device collects an image based on the automatic exposure mode, and obtains M shot images, M being an integer greater than or equal to 1. Finally, the image collection device determines a target shot image from the M shot images, the target shot image being a shot image having an image quality satisfying a preset image quality requirement.

For ease of understanding, with reference to FIG. 2, a diagram of an application environment of a photographing control method in an embodiment of this disclosure is shown. As shown in FIG. 2, the photographing control method in the embodiment of this disclosure is applied to the photographing control system. The disclosure of the photographing control method to a palm swiping payment scenario is described as an example in FIG. 2. The photographing control system includes: a payment system 100 and a merchant order reception system 200.

The merchant order reception system 200 may include an image collection device 200-1 and an order reception device 200-2. The image collection device 200-1 includes a camera, a lamp, and a distance sensor. First, when the distance sensor (for example, a Psensor) on the image collection device 200-1 determines that a palm is approaching, the lamp is activated and set to an illumination mode, so as to activate a white-light/infrared lamp to illuminate a palm. Next, an exposure mode is adjusted from a fixed exposure mode to an automatic exposure mode, and the palm is photographed in the automatic exposure mode. Finally, a target image through which identity recognition and verification can be performed is selected from shot images, so as to obtain payment information, and the payment information is transmitted to the order reception device 200-2. The order reception device 200-2 generates order information based on the payment information, and then transmits the order information to the payment system 100. The payment system 100 may be deemed as a settlement center of a merchant. After receiving the order information, the order reception device 200-2 verifies identity information of a user and a target shot image based on a user identifier in the order information, and deducts money after verification is passed.

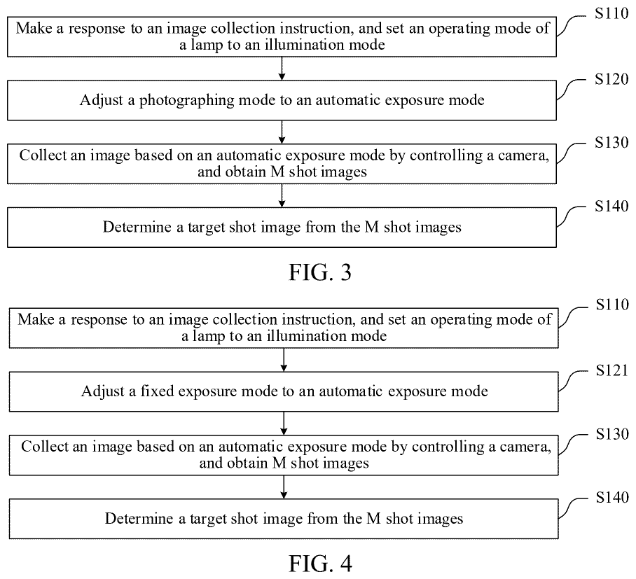

The photographing control method in this disclosure is described below from the perspective of the image collection device. With reference to FIG. 3, the photographing control method according to the embodiment of this disclosure is performed by the image collection device. The image collection device includes a camera and a lamp. The photographing control method includes: operation S110 to operation S140. Specifically:

S110: Make a response to an image collection instruction, and set an operating mode of the lamp to an illumination mode.

The illumination mode is configured for indicating that the lamp is in a high-brightness state, and in the high-brightness state, a light supplementation intensity of the lamp exceeds a preset intensity threshold.

When an image collection condition is not satisfied, the operating mode of the lamp is a breathing lamp mode, and an exposure mode is a fixed exposure mode. The breathing lamp mode indicates that the lamp emits out green light, and the light is in a flickering state. The green light gradually changes from bright to dark, so as to imitate a breathing state. In the breathing lamp mode, brightness of the lamp is low, for example, lower than a preset brightness threshold. The fixed exposure mode indicates an exposure mode based on preset fixed exposure parameters (including a fixed exposure time and a fixed exposure gain value). The fixed exposure parameter may be determined according to a historical exposure parameter corresponding to a target shot image having a high quality and obtained in an automatic exposure mode.

When the image collection condition is satisfied, the image collection instruction is generated. The image collection device makes a response to the image collection instruction, and adjusts the operating mode of the lamp to the illumination mode. Thus, the lamp on the image collection device is in a high-brightness state of a white-light/infrared lamp, so as to illuminate a palm. In other words, the lamp may illuminate the palm with light having high brightness.

The image collection condition indicates a condition configured for triggering the image collection device to collect the image. For example, whether the image collection condition is satisfied may be determined based on a relation between a distance value ranging from a target object to a camera and collected by a distance sensor (such as a P-sensor) on the image collection device and a distance threshold. For example, the distance threshold is 15 CM. When the distance value ranging from the target object to the camera and collected by the P-sensor is less than 15 CM, it indicates that the palm is currently approaching or a possibility of palm approaching exists. Thus, it may be deemed that the image collection condition is satisfied.

S120: Adjust a photographing mode to an automatic exposure mode.

When the image collection condition is not satisfied, the exposure mode is a fixed exposure mode. When the image collection condition is satisfied, the fixed exposure mode needs to be adjusted to the automatic exposure mode. The fixed exposure parameter of the fixed exposure mode may be determined according to the historical exposure parameter.

The fixed exposure parameter may be obtained by processing M groups of exposure parameters (each group of exposure parameters includes an exposure time and an exposure gain) by a fixed exposure parameter adjustment model. M is an integer greater than or equal to 1. Specifically:

Before the embodiment of this disclosure is executed, if photographing control has been performed more than M times according to the method according to the embodiments of this disclosure, and the M times of photographing control are performed in the same region as that for current photographing control or executed by the same image collection device as that for the current photographing control, M groups of historical exposure parameters correspond to nearly M historical target shot images are acquired (the M groups of historical exposure parameters correspond one-to-one to the M target shot images obtained). Next, the M groups of historical exposure parameters, input of the fixed exposure parameter adjustment model, are processed by the fixed exposure parameter adjustment model, so as to obtain the fixed exposure parameters (including the fixed exposure time and the fixed exposure gain). The fixed exposure parameter adjustment model is configured to generate the fixed exposure parameter according to the M groups of historical exposure parameters and recognition times of the target shot images corresponding to the M groups of historical exposure parameters. A difference range between the fixed exposure parameter and an automatic exposure parameter corresponding to the automatic exposure mode is less than a preset difference range threshold. Thus, an exposure parameter adjustment time in a process of adjusting from the fixed exposure mode to the automatic exposure mode is shortened, and precision of the exposure parameter is improved.

Before the embodiment of this disclosure is executed, if less than M times of photographing control have been performed according to the method according to the embodiments of this disclosure, M training reference images are acquired. Regional or environmental big data of the M training reference images are the same as or similar to those of current photographing control. Next, the M training reference images, input of an image exposure parameter analysis model, are analyzed by the image exposure parameter analysis model, so as to obtain M groups of reference exposure parameters corresponding to the M training reference images. Then, the M groups of reference exposure parameters, input of the fixed exposure parameter adjustment model, are processed by the fixed exposure parameter adjustment model, so as to obtain the fixed exposure parameters (including the fixed exposure time and the fixed exposure gain). The fixed exposure parameter adjustment model is configured to generate the fixed exposure parameter according to the M groups of reference exposure parameters. A difference range between the fixed exposure parameter and an automatic exposure parameter corresponding to the automatic exposure mode is less than a preset difference range threshold. Thus, an exposure parameter adjustment time in a process of adjusting from the fixed exposure mode to the automatic exposure mode is shortened, and precision of the exposure parameter is improved.

The difference range between the fixed exposure parameter and the automatic exposure parameter corresponding to the automatic exposure mode is less than the preset difference range threshold. Thus, the exposure parameter adjustment time can be shortened because when the difference range between the fixed exposure parameter and the automatic exposure parameter corresponding to the automatic exposure mode is less than the preset difference range threshold, a convergence time required for adjusting from the fixed exposure mode to the automatic exposure mode is short. For example, in a process of adjusting the fixed exposure mode to the automatic exposure mode, first, brightness in the fixed exposure mode is determined as 800 according to the historical exposure parameter corresponding to the target shot image having the high quality and obtained in the automatic exposure mode. The exposure time is calculated as 1.25 ms (1000/800) according to the formula that the exposure time=target brightness/illumination brightness. If the palm of the user is swiped, the image collection condition is satisfied, and the palm is 9 cm away from the image collection device, the operating mode of the lamp is set to the illumination mode, white light is activated for supplementation, and an image is collected. Image brightness of this frame can be calculated as 937.5 (1.25 (ms)×750 (a white-light lamp supplementation intensity generated when the palm is 9 cm away from the image collection device)) according to the formula that the image brightness=exposure time×lamp supplementation intensity. In this case, in an exposure process, the brightness needs to be adjusted from 937.5 to the target brightness 1000, where an exposure adjustment value is 62.5 (1000-937.5). It can be seen that the exposure adjustment value is small. Correspondingly, the exposure time required for shooting an image satisfying the target brightness is short, and a convergence speed is high.

S130: Collect an image based on the automatic exposure mode by controlling the camera, and obtain M shot images,

M being an integer greater than or equal to 1.

Continuous photographing is performed based on the automatic exposure mode, so as to obtain the M shot images obtained through continuous photographing.

S140: Determine a target shot image from the M shot images.

The target shot image is a shot image having an image quality satisfying a preset image quality requirement, for example, a shot image having resolution greater than preset resolution in the M shot images.

For example, the photographing control method according to the embodiments of this disclosure is used in two cases. In one case, the image collection condition is not satisfied, and in the other case, the image collection condition is satisfied.

First, a scenario where the image collection condition is not satisfied is described as follows: Automatic exposure parameters corresponding to target shot images obtained when palm swiping succeeds nearly 1000 times. The automatic exposure parameters corresponding to the target shot images obtained when palm swiping succeeds nearly 1000 times are historical exposure parameters and stored in a historical exposure parameter database. The fixed exposure parameter is determined according to the nearly 1000 historical exposure parameters. Specifically, the historical exposure parameter includes an exposure time and an exposure gain value. An average value of nearly 1000 exposure times may be used as the fixed exposure time of the fixed exposure parameter. An average value of nearly 1000 exposure gain values may be used as the exposure gain value of the fixed exposure parameter. Alternatively, a median value of nearly 1000 exposure times may be used as the fixed exposure time of the fixed exposure parameter, and a median value of nearly 1000 exposure gain values may be used as the exposure gain value of the fixed exposure parameter.

When the image collection condition is not satisfied, the operating mode of the lamp is a breathing lamp mode. In other words, the lamp emits out green light, and the light is in a flickering state. The green light gradually changes from bright to dark, so as to imitate a facial breathing state.

Next, a scenario where the image collection condition is satisfied is described as follows: It can be experientially known that during palm swiping, a distance between the palm and the image collection device is generally 5 cm to 12 cm, and a distance threshold is set to 15 cm experientially. A distance between the palm and the image collection device is determined based on a measurement result of a distance sensor. A response to the image collection instruction is made if the distance between the palm and the image collection device is less than the distance threshold 15 cm. No response to the image collection instruction is made if a distance between the palm and the image collection device is greater than or equal to the distance threshold 15 cm. In some examples, four P-sensors are arranged on the image collection device. When one P-sensor detects that the distance between the palm and the image collection device is less than the distance threshold 15 cm, the response to the image collection instruction is made.

When the distance between the palm and the image collection device is less than the distance threshold 15 cm, the response to the image collection instruction is made, and the operating mode of the lamp is changed from the breathing lamp mode to the illumination mode. In other words, the lamp on the image collection device is in a high-brightness state of a white-light/infrared lamp, so as to illuminate the palm. After the palm is illuminated, the photographing mode is adjusted from the fixed exposure mode to the automatic exposure mode. The palm is continuously photographed based on the automatic exposure mode, so as to obtain the M shot images. The shot image having the image quality satisfying the preset image quality requirement is selected from the M shot images as the target shot image. Finally, palmprint recognition and verification are performed on the target shot image.

This disclosure provides the photographing control method. The lamp is set to the illumination mode, so as to illuminate a target object when making a response to the image collection instruction, and thus the target object can be clearly imaged under sufficient light. Moreover, the exposure mode of the camera is adjusted from fixed exposure to automatic exposure for photographing, so that the image collected from the target object can be clear, and a success rate of verifying the target can be increased.

In the related art, there are two exposure modes: One is automatic exposure. An automatic exposure time is long and generally 200 ms to 400 ms. If a palm swiping process completely depends on the automatic exposure, the long exposure time is required, and thus the user cannot be provided with desirable palm swiping experience. The other one is fixed exposure. Compared with the automatic exposure, although an exposure adjustment time is omitted in the fixed exposure, so as to improve an exposure speed, a few ranges and light scenarios are adapted to the fixed exposure. In an indoor scenario, when a distance between the palm and a palm swiping terminal is within 6 CM to 9 CM, desirable palm swiping experience can be provided, but the fixed exposure cannot adapt to a full range of 3 CM to 12 CM defined by the palm swiping terminal or a scenario with outdoor light changed.

In order for exposure in the full range of 3 CM to 12 CM defined by the palm swiping terminal and shortening the exposure time, so as to provide the user with desirable palm swiping experience, in an exemplary embodiment of the photographing control method according to the embodiment corresponding to FIG. 3 of this disclosure, with reference to FIG. 4, operation S120 further includes sub-operation S121. Specifically:

S121: Adjust a fixed exposure mode to the automatic exposure mode.

A fixed exposure parameter value corresponding to the fixed exposure mode is determined according to a historical exposure parameter.

When a difference between a fixed exposure parameter of the fixed exposure mode and a target exposure parameter of the automatic exposure mode is small, an exposure time can be greatly shortened. Thus, it is of importance to set a proper fixed exposure parameter for shortening the exposure time. The fixed exposure parameter is determined according to a historical exposure parameter corresponding to a target shot image having a high quality and obtained in the automatic exposure mode.

For example, in an indoor scenario, assuming that an indoor average light intensity is 100, and the lamp on the image collection device operates in the illumination mode, a white-light lamp supplementation intensity at a position 7 cm away from the image collection device is 800, and target brightness is 1000.

If the automatic exposure mode is directly employed, the exposure time can be calculated as 10 ms (1000/100) according to the formula that the exposure time=target brightness/indoor average light intensity. If a palm of a user is swiped, the image collection condition is satisfied, and the palm is 7 cm away from the image collection device, an image is directly collected. Image brightness of this frame can be calculated as 8000 (10 (ms)×800) according to the formula that the image brightness=exposure time×lamp supplementation intensity. In this case, in an exposure process, the brightness needs to be adjusted from 8000 to the target brightness 1000, where an exposure adjustment value is 7000 (8000-1000). Owing to the large exposure adjustment value, an exposure time required for shooting an image satisfying the target brightness is long, and a convergence speed is low.

If the method in operation S121 in the embodiment of this disclosure is employed, in other words, the exposure mode of the camera is adjusted from the fixed exposure mode to the automatic exposure mode, first, the brightness of the fixed exposure mode is determined as 800 according to the historical exposure parameter corresponding to the target shot image with the high quality and obtained in the automatic exposure mode. The exposure time is calculated as 1.25 ms (1000/800) according to the formula that the exposure time=target brightness/illumination brightness. If the palm of the user is swiped, the image collection condition is satisfied, and the palm is 9 cm away from the image collection device, the operating mode of the lamp is set to the illumination mode, white light is activated for supplementation, and an image is collected. Image brightness of this frame can be calculated as 937.5 (1.25 (ms)×750 (a white-light lamp supplementation intensity generated when the palm is 9 cm away from the image collection device)) according to the formula that the image brightness=exposure time×lamp supplementation intensity. In this case, in an exposure process, the brightness needs to be adjusted from 937.5 to the target brightness 1000, where an exposure adjustment value is 62.5 (1000-937.5). Owing to the small exposure adjustment value, an exposure time required for shooting an image satisfying the target brightness is short, and a convergence speed is high.

This disclosure provides a photographing control method. The fixed exposure mode is set according to the fixed exposure parameter determined according to the historical exposure parameter corresponding to the target shot image having the high quality and obtained in the automatic exposure mode. When the image collection condition is satisfied, the fixed exposure mode is adjusted to the automatic exposure mode (e.g., parameter values in the fixed exposure mode are used as initial parameter values in the automatic exposure mode), so that the exposure adjustment value can be decreased, the exposure time can be short, and the convergence speed can be high.

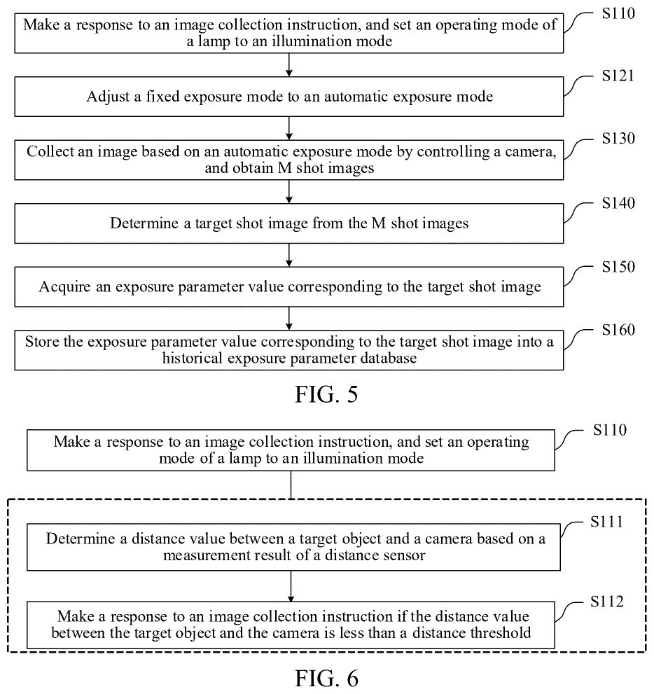

In an exemplary embodiment of the photographing control method according to the embodiment corresponding to FIG. 4 of this disclosure, with reference to FIG. 5, after operation S140, the method further includes operation S150 to operation S160. Specifically:
S150: Acquire an exposure parameter value corresponding to the target shot image.
S160: Store the exposure parameter value corresponding to the target shot image into the historical exposure parameter database.

A historical exposure parameter in the historical exposure parameter database is configured for adjusting a fixed exposure parameter value.

When a difference between a fixed exposure parameter of the fixed exposure mode and a target exposure parameter of the automatic exposure mode is small, an exposure time can be greatly shortened. Thus, it is of importance to set a proper fixed exposure parameter for shortening the exposure time. The fixed exposure parameter is determined according to a historical exposure parameter corresponding to a target shot image having a high quality and obtained in the automatic exposure mode. Thus, an exposure parameter value corresponding to the target shot image needs to be stored for subsequent adjustment of the fixed exposure parameter value.

For example, automatic exposure parameters corresponding to target shot images based on which palm swiping succeeds nearly 1000 times may be acquired. The automatic exposure parameters corresponding to the target shot images based on which palm swiping succeeds nearly 1000 times are the historical exposure parameters and stored in the historical exposure parameter database. The fixed exposure parameter is determined according to nearly 1000 historical exposure parameters. Specifically, the historical exposure parameter includes an exposure time and an exposure gain value. An average value of nearly 1000 exposure times may be used as a fixed exposure time of the fixed exposure parameter. An average value of nearly 1000 exposure gain values may be used as an exposure gain value of the fixed exposure parameter. Alternatively, a median value of nearly 1000 exposure times may be used as a fixed exposure time of the fixed exposure parameter, and a median value of nearly 1000 exposure gain values may be used as an exposure gain value of the fixed exposure parameter.

This disclosure provides a photographing control method. The exposure parameter value corresponding to the target shot image having the high quality is stored for subsequent adjustment of the fixed exposure parameter value. Thus, an exposure adjustment value from the fixed exposure parameter value to the target exposure parameter corresponding to the automatic exposure mode is decreased, the exposure time is shortened, and a foundation for improving a convergence speed of the exposure parameter is laid.

In an exemplary embodiment of the photographing control method according to the embodiment corresponding to FIG. 3 of this disclosure, the image collection device further includes a distance sensor. With reference to FIG. 6, operation S110 further includes sub-operation S111 to sub-operation S112. Specifically:

S111: Determine a distance value between the target object and the camera based on a measurement result of the distance sensor.

The distance sensor in the embodiment of this disclosure may be a P-sensor. The distance sensor may sense a distance between the image collection device and the palm, so as to determine whether to make a response to the image collection instruction.

S112: Make a response to the image collection instruction if the distance value between the target object and the camera is less than a distance threshold.

The distance threshold is set experientially. When the distance value between the target object and the camera is less than the distance threshold, the response to the image collection instruction is made.

For example, it can be experientially known that during palm swiping, a distance between the palm and the image collection device is generally 5 cm to 12 cm, and the distance threshold is set to 15 cm experientially. The distance between the palm and the image collection device is acquired based on the measurement result of the distance sensor. The response to the image collection instruction is made if the distance between the palm and the image collection device is less than the distance threshold 15 cm. In some examples, four P-sensors are arranged on the image collection device. When one P-sensor detects that the distance between the palm and the image collection device is less than the distance threshold 15 cm, the response to the image collection instruction is made.

When the distance between the palm and the image collection device is less than the distance threshold 15 cm, the response to the image collection instruction is made, and the operating mode of the lamp is changed from the breathing lamp mode to the illumination mode. In other words, the lamp on the image collection device is in a high-brightness state of a white-light/infrared lamp, so as to illuminate the palm. After the palm is illuminated, the exposure mode is adjusted from the fixed exposure mode to the automatic exposure mode. The palm is continuously photographed based on the automatic exposure mode, so as to obtain the M shot images. The shot image having the image quality satisfying the preset image quality requirement is selected from the M shot images as the target shot image. Finally, palmprint recognition and verification are performed on the target shot image.

This disclosure provides a photographing control method. The distance value between the target object and the camera acquired based on the measurement result of the distance sensor is compared with the distance threshold, so as to determine whether to make a response to the image collection instruction. Thus, a foundation for decreasing an exposure adjustment value and realizing a short exposure time and a high convergence speed is laid.

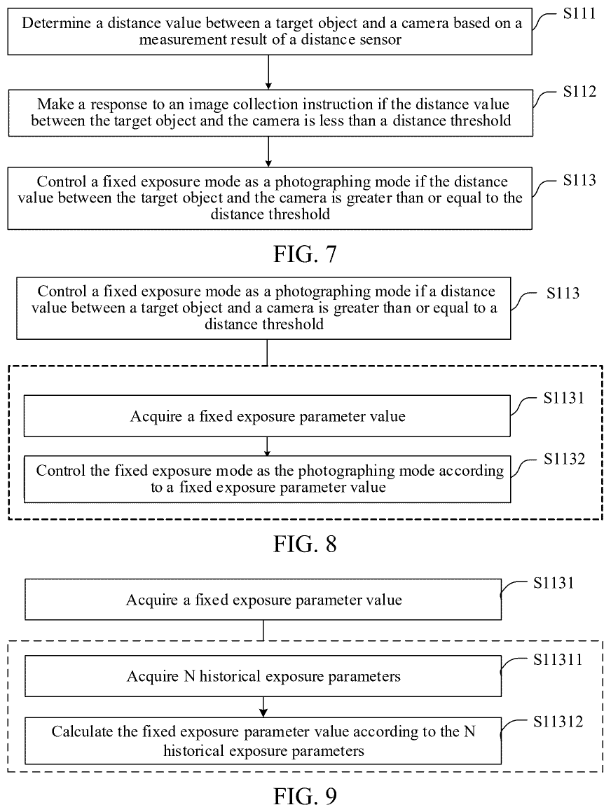

In an exemplary embodiment of the photographing control method according to the embodiment corresponding to FIG. 6 of this disclosure, with reference to FIG. 7, after operation S112, the method further includes operation S113. Specifically:

S113: Control the fixed exposure mode as the photographing mode if the distance value between the target object and the camera is greater than or equal to the distance threshold.

The distance threshold is set experientially. When the distance value between the target object and the camera is greater than or equal to the distance threshold, the photographing mode is set to the fixed exposure mode. When the distance value between the target object and the camera is greater than or equal to the distance threshold, it may be deemed that no palm swiping is performed.

It can be experientially known that during palm swiping, a distance between the palm and the image collection device is generally 5 cm to 12 cm, and a distance threshold is set to 15 cm experientially. The distance between the palm and the image collection device is acquired based on a measurement result of the distance sensor. No response to the image collection instruction is made if the distance between the palm and the image collection device is greater than or equal to the distance threshold 15 cm. In some examples, four P-sensors are arranged on the image collection device. If none of the four P-sensors detects that the distance between the palm and the image collection device is less than the distance threshold 15 cm, no response to the image collection instruction is made, and the fixed exposure mode continues being maintained as the photographing mode.

This disclosure provides a photographing control method. The distance value between the target object and the camera acquired based on the measurement result of the distance sensor is compared with the distance threshold, so as to determine whether to make a response to the image collection instruction. Thus, a foundation for decreasing an exposure adjustment value and realizing a short exposure time and a high convergence speed is laid.

In an exemplary embodiment of the photographing control method according to the embodiment corresponding to FIG. 7 of this disclosure, with reference to FIG. 8, operation S113 further includes sub-operation S1131 to sub-operation S1132. Specifically:

S1131: Acquire a fixed exposure parameter value.

The fixed exposure parameter value is pre-calculated. The fixed exposure parameter value may be calculated according to automatic exposure parameters corresponding to target shot images based on which palm swiping succeeds nearly 1000 times. Specifically: The automatic exposure parameters corresponding to the target shot images based on which palm swiping succeeds nearly 1000 times. The automatic exposure parameters corresponding to the target shot images based on which palm swiping succeeds nearly 1000 times are historical exposure parameters and stored in the historical exposure parameter database. The fixed exposure parameter is determined according to nearly 1000 historical exposure parameters. Specifically, the historical exposure parameter includes an exposure time and an exposure gain value. An average value of nearly 1000 exposure times may be used as a fixed exposure time of the fixed exposure parameter. An average value of nearly 1000 exposure gain values may be used as an exposure gain value of the fixed exposure parameter. Alternatively, a median value of nearly 1000 exposure times may be used as a fixed exposure time of the fixed exposure parameter, and a median value of nearly 1000 exposure gain values may be used as an exposure gain value of the fixed exposure parameter. A difference between the fixed exposure parameter value and a target exposure parameter value is small.

S1132: Control the fixed exposure mode as the photographing mode according to the fixed exposure parameter value.

The fixed exposure mode is controlled as the photographing mode according to the fixed exposure parameter value. In a scenario where the image collection condition is not satisfied, the photographing mode is set to the fixed exposure mode by default. The scenario where the image collection condition is not satisfied indicates that it can be experientially know that the distance between the palm and the image collection device is generally 5 cm to 12 cm during palm swiping, and the distance threshold is set to 15 cm experientially. The distance between the palm and the image collection device is acquired based on a measurement result of the distance sensor. The scenario where the image collection condition is not satisfied is generated if the distance between the palm and the image collection device is greater than or equal to the distance threshold 15 cm.

This disclosure provides a photographing control method. In the scenario where the image collection condition is not satisfied, the fixed exposure mode is controlled as the photographing mode according to the fixed exposure parameter value. The fixed exposure parameter value corresponding to the fixed exposure mode may be determined according to a historical exposure parameter value, and a difference from the target exposure parameter value is small. Thus, an exposure time is shortened, and a convergence speed is improved.

In an exemplary embodiment of the photographing control method according to the embodiment corresponding to FIG. 8 of this disclosure, with reference to FIG. 9, operation S1131 further includes sub-operation S11311 to sub-operation S11312. Specifically:

S11311: Acquire N historical exposure parameters.

The historical exposure parameter may be an exposure parameter corresponding to a shot image having an image quality satisfying the preset image quality requirement, for example, an exposure parameter corresponding to a shot image having resolution satisfying preset resolution, N being an integer greater than or equal to 1, and N being equal to 1000, for example.

S11312: Calculate a fixed exposure parameter value according to the N historical exposure parameters.

Automatic exposure parameters corresponding to target shot images based on which palm swiping succeeds nearly 1000 times may be acquired. The automatic exposure parameters corresponding to the target shot images based on which palm swiping succeeds nearly 1000 times are historical exposure parameters and stored in the historical exposure parameter database. The fixed exposure parameter is determined according to the nearly 1000 historical exposure parameters. Specifically, the historical exposure parameter includes an exposure time and an exposure gain value. An average value of nearly 1000 exposure times may be used as a fixed exposure time of the fixed exposure parameter. An average value of nearly 1000 exposure gain values may be used as an exposure gain value of the fixed exposure parameter. Alternatively, a median value of nearly 1000 exposure times may be used as a fixed exposure time of the fixed exposure parameter, and a median value of nearly 1000 exposure gain values may be used as an exposure gain value of the fixed exposure parameter.

This disclosure provides a photographing control method. The fixed exposure parameter value is calculated according to the automatic exposure parameters corresponding to the target shot images based on which palm swiping succeeds nearly 1000 times. A difference between the fixed exposure parameter value and a target exposure parameter value corresponding to the automatic exposure mode is small. Thus, an exposure adjustment value is small, the exposure time is short, and a convergence speed is high.

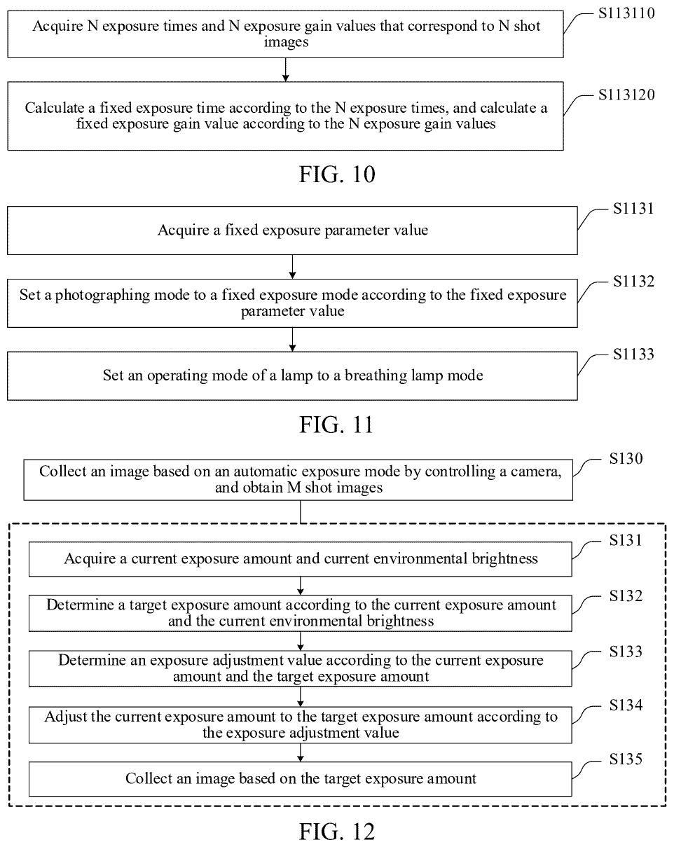

In an exemplary embodiment of the photographing control method according to the embodiment corresponding to FIG. 9 of this disclosure, with reference to FIG. 10, sub-operation S11311 further includes sub-operation S113110, and sub-operation S11312 further includes sub-operation S113120. Specifically:
S113110: Acquire N exposure times and N exposure gain values that correspond to N shot images.
S113120: Calculate a fixed exposure time according to the N exposure times, and calculate a fixed exposure gain value according to the N exposure gain values.

Automatic exposure parameters corresponding to target shot images based on which palm swiping succeeds nearly 1000 times are acquired. The automatic exposure parameters corresponding to the target shot images based on which palm swiping succeeds nearly 1000 times are historical exposure parameters and stored in the historical exposure parameter database. The fixed exposure parameter is determined according to nearly 1000 historical exposure parameters. Specifically, the historical exposure parameter includes an exposure time and an exposure gain value. An average value of nearly 1000 exposure times may be used as a fixed exposure time of the fixed exposure parameter. An average value of nearly 1000 exposure gain values may be used as a fixed exposure gain value of the fixed exposure parameter. Alternatively, a median value of nearly 1000 exposure times may be used as a fixed exposure time of the fixed exposure parameter, and a median value of nearly 1000 exposure gain values may be used as a fixed exposure gain value of the fixed exposure parameter.

This disclosure provides a photographing control method. The fixed exposure time and the fixed exposure gain value in the fixed exposure parameter values are determined correspondingly through the exposure times and the exposure gain values that correspond to the target shot images based on which palm swiping succeeds nearly 1000 times. Thus, a difference between the fixed exposure parameter value and a target fixed exposure parameter value is small. In other words, an exposure adjustment value is small, the exposure time is short, and a convergence speed is high.

In an exemplary embodiment of the photographing control method according to the embodiment corresponding to FIG. 7 of this disclosure, with reference to FIG. 11, after operation S1132, the method further includes operation S1133. Specifically:

S1133: Set an operating mode of the lamp to a breathing lamp mode.

In a scenario where the image collection condition is not satisfied, the operating mode of the lamp is the breathing lamp mode. In other words, the lamp emits out green light, and the light is in a flickering state. The green light gradually changes from bright to dark, so as to imitate human breathing.

When the image collection condition is satisfied, the operating mode of the lamp is changed from the breathing lamp mode to the illumination mode. In other words, the lamp on the image collection device is in a high-brightness state of a white-light/infrared lamp, so as to illuminate a palm for photographing.

This disclosure provides a photographing control method. In the scenario where the image collection condition is not satisfied, the operating mode of the lamp is set to the breathing lamp mode. Setting the breathing lamp indicates that the image collection device is currently in an operating state, and has a light emitting effect distinguished from that when the lamp operates in the illumination mode.

In an exemplary embodiment of the photographing control method according to the embodiment corresponding to FIG. 3 of this disclosure, with reference to FIG. 12, operation S130 includes sub-operation S131 to sub-operation S135. Specifically:
S131: Acquire a current exposure amount and current environmental brightness.
S132: Determine a target exposure amount according to the current exposure amount and the current environmental brightness.
S133: Determine an exposure adjustment value according to the current exposure amount and the target exposure amount.
S134: Adjust the current exposure amount to the target exposure amount according to the exposure adjustment value.
S135: Collect the image based on the target exposure amount.

After the target exposure amount is determined according to the current exposure amount and the current environmental brightness, when an automatic exposure adjustment is performed, a difference between the target exposure amount and the current exposure amount is determined as an adjustment step value. Accordingly, the current exposure amount is directly adjusted to the target exposure amount, so that breakdown exposure is implemented, and an exposure time is shortened

For example, in an indoor scenario, assuming that an indoor average light intensity is 100, and the lamp on the image collection device operates in the illumination mode, a white-light lamp supplementation intensity at a position 7 cm away from the image collection device is 800, and target brightness is 1000.

If the automatic exposure mode is directly employed, the exposure time can be calculated as 10 ms (1000/100) according to the formula that the exposure time=target brightness/indoor average light intensity. If a palm of a user is swiped, the image collection condition is satisfied, and the palm is 7 cm away from the image collection device, an image is directly collected. Image brightness of this frame can be calculated as 8000(10(ms)×800) according to the formula that the image brightness=exposure time×lamp supplementation intensity. In this case, in an exposure process, the brightness needs to be adjusted from 8000 to the target brightness 1000, where an exposure adjustment value is 7000 (8000-1000). Owing to the large exposure adjustment value, an exposure time required for shooting an image satisfying the target brightness is long, and a convergence speed is low.

If the method in the embodiment of this disclosure is employed, in other words, the fixed exposure mode is adjusted to the automatic exposure mode in a scenario where the image collection condition is satisfied, first, brightness in the fixed exposure mode is determined as 800 according to a historical exposure parameter corresponding to a target shot image having a high quality and obtained in the automatic exposure mode. The exposure time is calculated as 1.25 ms (1000/800) according to the formula that the exposure time=target brightness/illumination brightness. If the palm of the user is swiped, the image collection condition is satisfied, and the palm is 9 cm away from the image collection device, the operating mode of the lamp is set to the illumination mode, white light is activated for supplementation, and an image is collected. Image brightness of this frame can be calculated as 937.5 (1.25(ms)×750 (a white-light lamp supplementation intensity generated when the palm is 9 cm away from the image collection device)) according to the formula that the image brightness=exposure time×lamp supplementation intensity. In this case, in an exposure process, the brightness needs to be adjusted from 937.5 to the target brightness 1000, where an exposure adjustment value is 62.5 (1000-937.5). Owing to the small exposure adjustment value, an exposure time required for shooting an image satisfying the target brightness is short, and a convergence speed is high.

In an outdoor scenario, assuming that an outdoor average light intensity is 1000, and the lamp on the image collection device operates in the illumination mode, a white-light lamp supplementation intensity at a position 7 cm away from the image collection device is 800, and target brightness is 1000.

If the method in the embodiment of this disclosure is employed, in other words, the fixed exposure mode is adjusted to the automatic exposure mode in a scenario where the image collection condition is satisfied, first, brightness of the fixed exposure mode is determined as 800 according to a historical exposure parameter corresponding to a target shot image having a high quality and obtained in the automatic exposure mode. The exposure time is calculated as 1.25 ms (1000/800) according to the formula that the exposure time=target brightness/illumination brightness. If the palm of the user is swiped, the image collection condition is satisfied, and the palm is 9 cm away from the image collection device, the operating mode of the lamp is set to the illumination mode, white light is activated for supplementation, and the image is collected. Image brightness of this frame can be calculated as 1250 (1.25(ms)×1000 (the outdoor average light intensity is 1000)) according to the formula that the image brightness=exposure time×lamp supplementation intensity. In this case, in an exposure process, the brightness needs to be adjusted from 1250 to the target brightness 1000, where an exposure adjustment value is 250 (1250-1000). Owing to the small exposure adjustment value, an exposure time required for shooting an image satisfying the target brightness is short, and a convergence speed is high.

This disclosure provides a photographing control method. The target exposure amount is determined according to the current environmental brightness and the current exposure amount. The exposure adjustment value is calculated according to the target exposure amount. Thus, by decreasing the exposure adjustment value, the exposure time is short, and the convergence speed is high.

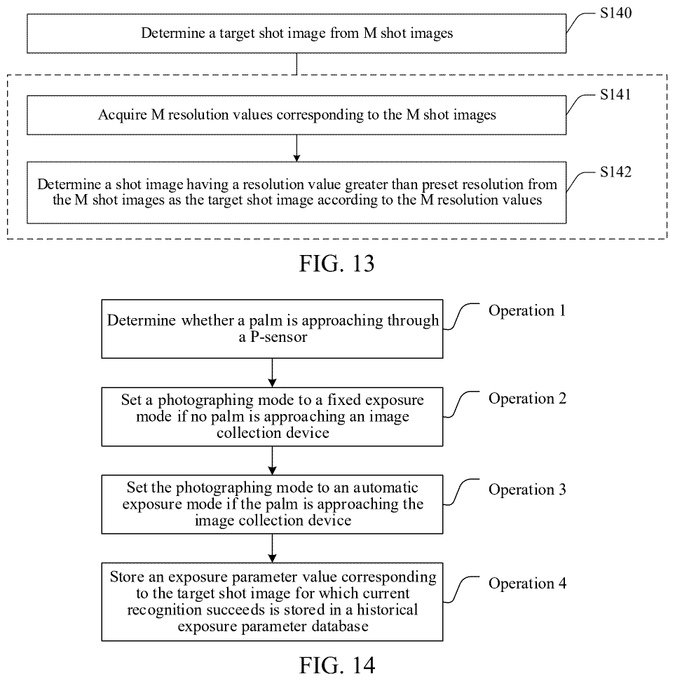

In an exemplary embodiment of the photographing control method according to the embodiment corresponding to FIG. 3 of this disclosure, with reference to FIG. 13, operation S140 includes sub-operation S141 to sub-operation S142. Specifically:
S141: Acquire M resolution values corresponding to the M shot images.
S142: Determine a shot image having a resolution value greater than preset resolution from the M shot images as the target shot image according to the M resolution values.

The shot image having the resolution value greater than the preset resolution may be selected as the target shot image according to resolution of images continuously shot. If there are a plurality of shot images having resolution values greater than the preset resolution, a shot image having the greatest resolution is selected as the target shot image. If there is no shot image having a resolution value greater than the preset resolution, a photographing failure is returned, and re-photographing is requested.

This disclosure provides a photographing control method. The target shot image is selected according to photographing resolution of the images. Thus, accuracy of determining the target shot image is improved, and further, the fixed exposure parameter value corresponding to the fixed exposure mode is adjusted through an exposure parameter value of the target shot image, and a foundation for shortening an exposure time and improving a convergence speed is laid.

For ease of understanding, a photographing control method applied to a palm swiping scenario is described below in conjunction with FIG. 14. The photographing control method applied to the palm swiping scenario includes four operations. Specifically:

Operation 1: Determine whether a palm is approaching through a P-sensor.

It can be experientially known that during palm swiping, a distance between the palm and the image collection device is generally 5 cm to 12 cm, and a distance threshold is set to 15 cm experientially. The distance between the palm and the image collection device is acquired based on a measurement result of the distance sensor. A response to the image collection instruction is made if the distance between the palm and the image collection device is less than the distance threshold 15 cm. No response to the image collection instruction is made if the distance between the palm and the image collection device is greater than or equal to the distance threshold 15 cm. In some examples, four P-sensors are arranged on the image collection device. When one P-sensor detects that the distance between the palm and the image collection device is less than the distance threshold 15 cm, the response to the image collection instruction is made. In some examples, if the distance between the palm and the image collection device is equal to 12 cm, a success rate of palm swiping can be increased, and 12 cm is taken as an optimal distance value for palm swiping, so as to provide better palm swiping experience.

Operation 2: Control a fixed exposure mode as a photographing mode when no palm is approaching the image collection device.

In other words, in a scenario where no response to the image collection instruction is made, the fixed exposure mode may be maintained as the photographing mode. A fixed exposure parameter value of the fixed exposure mode may be determined as follows:

Automatic exposure parameters corresponding to target shot images based on which palm swiping succeeds nearly 1000 times. The automatic exposure parameters corresponding to the target shot images based on which palm swiping succeeds nearly 1000 times are historical exposure parameters and stored in the historical exposure parameter database. A fixed exposure parameter is determined according to nearly 1000 historical exposure parameters. Specifically, the historical exposure parameter includes an exposure time and an exposure gain value. An average value of nearly 1000 exposure times may be used as a fixed exposure time of the fixed exposure parameter. An average value of nearly 1000 exposure gain values may be used as an exposure gain value of the fixed exposure parameter. Alternatively, a median value of nearly 1000 exposure times may be used as a fixed exposure time of the fixed exposure parameter, and a median value of nearly 1000 exposure gain values may be used as an exposure gain value of the fixed exposure parameter.

In addition, when an image collection condition is not satisfied, an operating mode of a lamp is a breathing lamp mode. In other words, the lamp emits out green light, and the light is in a flickering state. The green light gradually changes from bright to dark, so as to imitate a human breathing state.
Operation 3: Set an automatic exposure mode as the photographing mode when the palm is approaching the image collection device.

In other words, in a scenario of making a response to the image collection instruction, the photographing mode may be adjusted from the fixed exposure mode to the automatic exposure mode (e.g., the parameter values in the fixed exposure mode are the initial values of the parameters in the automatic exposure mode). When the initial values are close to the target values of the parameters, fast AE can be achieved.

When the distance between the palm and the image collection device is less than the distance threshold 15 cm, the response to the image collection instruction is made, and the operating mode of the lamp is changed from the breathing lamp mode to an illumination mode. In other words, the lamp on the image collection device is in a high-brightness state of a white-light/infrared lamp, so as to illuminate the palm. After the palm is illuminated, the photographing mode is adjusted from the fixed exposure mode to the automatic exposure mode. The palm is continuously photographed based on the automatic exposure mode, so as to obtain M shot images. A shot image having resolution greater than preset resolution is selected from the M shot images as a target shot image. Finally, palmprint recognition and verification are performed on the target shot image.

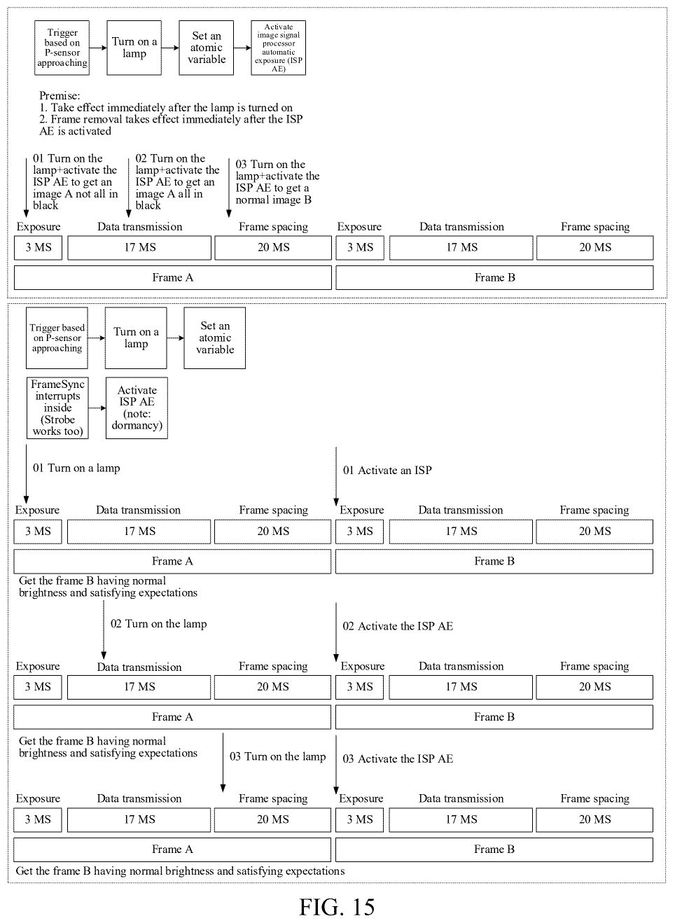

With reference to FIG. 15, a sequence diagram of exposure is shown. To ensure a success rate, the palm needs to be illuminated first, and then the photographing mode is adjusted to the automatic exposure mode, so that a first frame acquired by the image collection device is an image illuminated with the lamp activated and having automatic exposure (AE) with a fixed empirical value (e.g., as an initial value for the AE). In this way, rapid palm swiping can be achieved, and the AE takes effect. If the first frame acquired by the image collection device does not match a case where the lamp is activated for illumination: If the first frame provided for the automatic exposure (AE) of the image collection device is not illuminated with the lamp, first-frame AE of the image collection device fails, and a very long AE convergence process is caused, so that a palm swiping speed is low.
Operation 4: Store an exposure parameter value corresponding to the target shot image for which current recognition succeeds into the historical exposure parameter database.

When a difference between a fixed exposure parameter of the fixed exposure mode and a target exposure parameter of the automatic exposure mode is small, an exposure time can be greatly shortened. Thus, it is of importance to set a proper fixed exposure parameter for shortening the exposure time. The fixed exposure parameter is determined according to a historical exposure parameter corresponding to a target shot image having a high quality and obtained in the automatic exposure mode. Thus, the exposure parameter value corresponding to the target shot image needs to be stored for subsequent adjustment of a fixed exposure parameter value.

For example, in an indoor scenario, assuming that an indoor average light intensity is 100, and the lamp on the image collection device operates in the illumination mode, a white-light lamp supplementation intensity at a position 7 cm away from the image collection device is 800, and target brightness is 1000.

If the automatic exposure mode is directly employed, the exposure time can be calculated as 10 ms (1000/100) according to the formula that the exposure time=target brightness/indoor average light intensity. If a palm of a user is swiped, the image collection condition is satisfied, and the palm is 7 cm away from the image collection device, an image is directly collected. Image brightness of this frame can be calculated as 8000 (10(ms)×800) according to the formula that the image brightness=exposure time×lamp supplementation intensity. In this case, in an exposure process, the brightness needs to be adjusted from 8000 to the target brightness 1000, where an exposure adjustment value is 7000 (8000-1000). Owing to the large exposure adjustment value, an exposure time required for shooting an image satisfying the target brightness is long, and a convergence speed is low.

If the method in the embodiment of this disclosure is employed, that is, the fixed exposure mode is adjusted to the automatic exposure mode, first, brightness in the fixed exposure mode is determined as 800 according to a historical exposure parameter corresponding to a successful target shot image in the automatic exposure mode. The exposure time is calculated as 1.25 ms (1000/800) according to the formula that the exposure time=target brightness/illumination brightness. If the palm of the user is swiped, the image collection condition is satisfied, and the palm is 9 cm away from the image collection device, the operating mode of the lamp is set to the illumination mode, white light is activated for supplementation, and an image is collected. Image brightness of this frame can be calculated as 937.5 (1.25 (ms)×750 (a white-light lamp supplementation intensity generated when the palm is 9 cm away from the image collection device)) according to the formula that the image brightness=exposure time×lamp supplementation intensity. In this case, in an exposure process, the brightness needs to be adjusted from 937.5 to the target brightness 1000, where an exposure adjustment value is 62.5 (1000-937.5). Owing to the small exposure adjustment value, an exposure time required for shooting an image satisfying the target brightness is short, and a convergence speed is high.

In an outdoor scenario, assuming that an outdoor average light intensity is 1000, and the lamp on the image collection device operates in the illumination mode, a white-light lamp supplementation intensity at a position 7 cm away from the image collection device is 800, and target brightness is 1000.

If the method in the embodiment of this disclosure is employed, that is, the fixed exposure mode is adjusted to the automatic exposure mode, first, brightness in the fixed exposure mode is determined as 800 according to a historical exposure parameter corresponding to a successful target shot image in the automatic exposure mode. The exposure time is calculated as 1.25 ms (1000/800) according to the formula that the exposure time=target brightness/illumination brightness. If a palm of a user is swiped, the image collection condition is satisfied, and the palm is 9 cm away from the image collection device, the operating mode of the lamp is set to the illumination mode, white light is activated for supplementation, and an image is collected. Image brightness of this frame can be calculated as 1250 (1.25 (ms)×1000 (the outdoor average light intensity is 1000)) according to the formula that the image brightness=exposure time×lamp supplementation intensity. In this case, in an exposure process, the brightness needs to be adjusted from 1250 to the target brightness 1000, where an exposure adjustment value is 250 (1250-1000). Owing to the small exposure adjustment value, an exposure time required for shooting an image satisfying the target brightness is short, and a convergence speed is high.

This disclosure provides a photographing control method. The lamp is set to the illumination mode, so as to illuminate a target object when making a response to the image collection instruction, and thus the target object can be clearly imaged under sufficient light. After the target object is illuminated, fixed exposure is adjusted to automatic exposure for photographing, so that the image collected from the target object can be clear, and a success rate of verifying the target object can be increased. The fixed exposure mode is set according to the fixed exposure parameter determined according to the historical exposure parameter corresponding to the target shot image having the high quality and obtained in the automatic exposure mode. When the image collection condition is satisfied, the fixed exposure mode is adjusted to the automatic exposure mode, so that the exposure adjustment value can be decreased, the exposure time can be short, and the convergence speed is high.

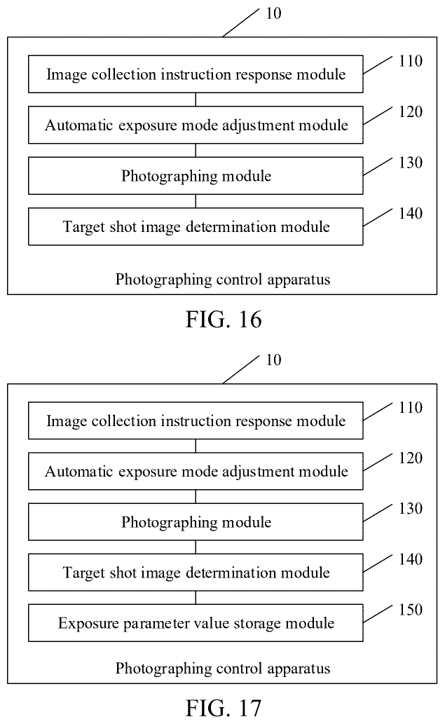

A photographing control apparatus in this disclosure is described in detail below. With reference to FIG. 16, a schematic diagram of an embodiment of a photographing control apparatus 10 in the embodiments of this disclosure is shown. The photographing control apparatus 10 includes: an image collection instruction response module 110, an automatic exposure mode adjustment module 120, a photographing module 130, and a target shot image determination module 140. Specifically:

The image collection instruction response module 110 is configured to make a response to an image collection instruction and activate an illumination mode.

The illumination mode is configured for indicating that a lamp is in a high-brightness state, and in the high-brightness state, a light supplementation intensity of the lamp exceeds a preset intensity threshold.

The automatic exposure mode adjustment module 120 is configured to adjust a photographing mode to an automatic exposure mode.

The photographing module 130 is configured to collect an image based on the automatic exposure mode by controlling the camera, and obtain M shot images.

M is an integer greater than or equal to 1.

The target shot image determination module 140 is configured to determine a target shot image from the M shot images.

The target shot image is a shot image having an image quality satisfying a preset image quality requirement.

This disclosure provides a photographing control apparatus. The lamp is set to the illumination mode, so as to illuminate a target object when making a response to the image collection instruction, and thus the target object can be clearly imaged under sufficient light. After the target object is illuminated, a fixed exposure mode is adjusted to the automatic exposure mode for photographing, so that the image collected from the target object can be clear, and a success rate of verifying the target object can be increased.

In an exemplary embodiment of the photographing control apparatus according to the embodiment corresponding to FIG. 16 of this disclosure, the automatic exposure mode adjustment module 120 is specifically configured to:
adjust the fixed exposure mode to the automatic exposure mode, a fixed exposure parameter value corresponding to the fixed exposure mode being determined according to a historical exposure parameter.

In an exemplary embodiment of the photographing control apparatus according to the embodiment corresponding to FIG. 16 of this disclosure, with reference to FIG. 17, the photographing control apparatus 10 further includes: an exposure parameter value storage module 150 configured to:
acquire an exposure parameter value corresponding to the target shot image; and
store the exposure parameter value corresponding to the target shot image into a historical exposure parameter database.

The historical exposure parameter in the historical exposure parameter database is configured for adjusting the fixed exposure parameter value.

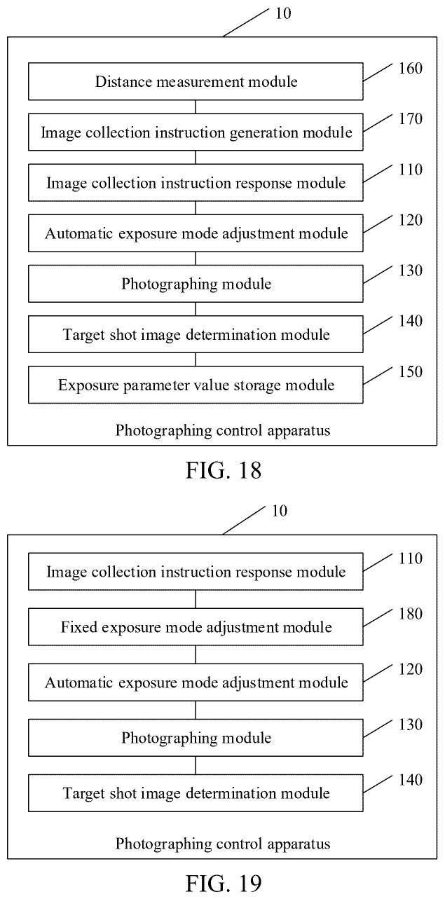

In an exemplary embodiment of the photographing control apparatus according to the embodiment corresponding to FIG. 16 of this disclosure, with reference to FIG. 18, the photographing control apparatus 10 further includes: a distance measurement module 160 and an image collection instruction generation module 170. Specifically:

The distance measurement module 160 is configured to determine a distance value between the target object and the camera based on a measurement result of the distance sensor.

The image collection instruction generation module 170 is configured to generate the image collection instruction if the distance value between the target object and the camera is less than a distance threshold.

In an exemplary embodiment of the photographing control apparatus according to the embodiment corresponding to FIG. 16 of this disclosure, with reference to FIG. 19, the photographing control apparatus 10 further includes: a fixed exposure mode adjustment module 180. Specifically:

The fixed exposure mode adjustment module 180 is configured to control the fixed exposure mode as the photographing mode if a distance value between the target object and the camera is greater than or equal to a distance threshold.

In an exemplary embodiment of the photographing control apparatus according to the embodiment corresponding to FIG. 19 of this disclosure, the fixed exposure mode adjustment module 180 is further configured to:
acquire a fixed exposure parameter value; and
control the fixed exposure mode as the photographing mode according to the fixed exposure parameter value.

In an exemplary embodiment of the photographing control apparatus according to the embodiment corresponding to FIG. 19 of this disclosure, the fixed exposure mode adjustment module 180 is further configured to:
acquire N historical exposure parameters,
the historical exposure parameters being exposure parameters corresponding to the shot images satisfying the preset image quality requirement; and
calculate the fixed exposure parameter value according to the N historical exposure parameters.

In an exemplary embodiment of the photographing control apparatus according to the embodiment corresponding to FIG. 19 of this disclosure, the fixed exposure mode adjustment module 180 is further configured to:
acquire N exposure times and N exposure gain values that correspond to N shot images, N being an integer greater than 1.

The calculation of the fixed exposure parameter value according to the N historical exposure parameters includes:
a fixed exposure time is calculated according to the N exposure times, and a fixed exposure gain value is calculated according to the N exposure gain values.

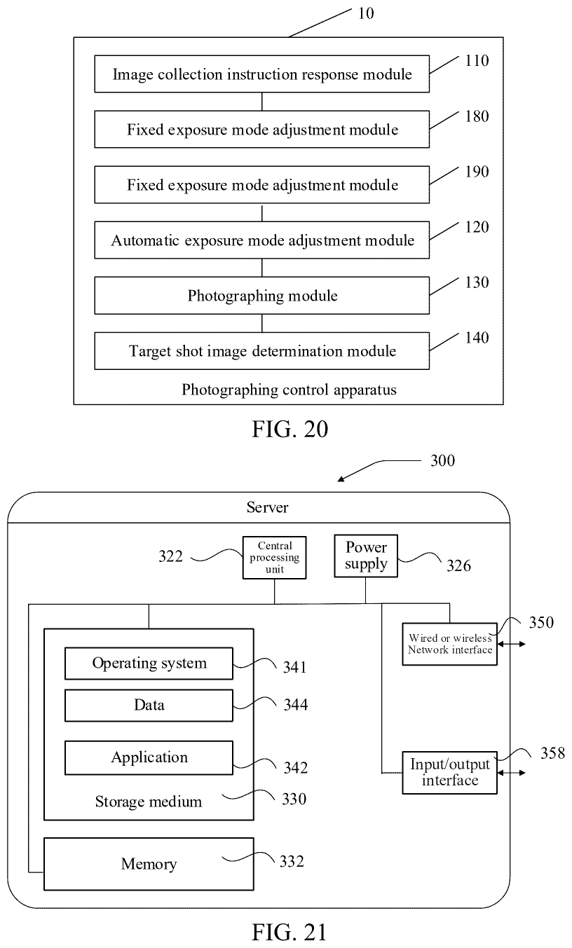

In an exemplary embodiment of the photographing control apparatus according to the embodiment corresponding to FIG. 19 of this disclosure, with reference to FIG. 20, the photographing control apparatus 10 further includes: a breathing lamp mode adjustment module 190 configured to: set the operating mode of the lamp to a breathing lamp mode.

In an exemplary embodiment of the photographing control apparatus according to the embodiment corresponding to FIG. 16 of this disclosure, the photographing module 130 is further configured to:
acquire a current exposure amount and current environmental brightness;
determine a target exposure amount according to the current exposure amount and the current environmental brightness;
determine an exposure adjustment value according to the current exposure amount and the target exposure amount;
adjust the current exposure amount to the target exposure amount according to the exposure adjustment value; and
collect the image based on the target exposure amount.

In an exemplary embodiment of the photographing control apparatus according to the embodiment corresponding to FIG. 16 of this disclosure, the target shot image determination module 140 is further configured to:
acquire M resolution values corresponding to the M shot images; and
determine a shot image having a resolution value greater than preset resolution from the M shot images as the target shot image according to the M resolution values.

FIG. 21 is a schematic structural diagram of a server according to an embodiment of this disclosure. The server 300 may be configured to perform the photographing control method according to the embodiments of this disclosure. The server 300 may vary greatly due to different configurations or performance, and may include one or more central processing units (CPUs) 322 (for example, one or more processors), a memory 332, and one or more storage media 330 (for example, one or more mass storage devices) that store an application program 342 or data 344. The memory 332 and the storage medium 330 may be transient or persistent storages. The program stored in the storage medium 330 may include one or more modules (not shown in the figure), and each module may include a series of instruction operations for the server. Furthermore, the central processing unit 322 may be configured to communicate with the storage medium 330, and execute, on the server 300, a series of instruction operations in the storage medium 330.

The server 300 may further include one or more power supplies 326, one or more wired or wireless network interfaces 350, one or more input/output interfaces 358, and/or one or more operating systems 341 such as Windows Server™, Mac OS X™, Unix™, Linux™, and FreeBSD™.

Operations executed by the server in the above embodiment may be based on the structure of the server shown in FIG. 21.

Those skilled in the art can clearly understand that for convenience and conciseness of description, reference can be made to the corresponding processes in the foregoing method embodiments for specific working processes of the above systems, apparatuses, and units, which will not be repeated herein.

In several embodiments provided in this disclosure, the system, apparatus, and method disclosed can be implemented in other ways. For example, the above apparatus embodiments are merely illustrative. For example, the unit is divided merely by logical function, and other division methods can be employed during actual implementation. For example, a plurality of units or components can be combined or integrated into another system, and alternatively, some features can be ignored or not executed. In addition, the displayed or discussed mutual couplings, direct couplings, or communication connections can be implemented through some interfaces. The indirect couplings or communication connections between the apparatuses or units can be implemented electrically, mechanically, etc.

The units described as separate parts can be physically separate or not, and the components displayed as units can be physical units or not, i.e. located in one position or distributed on a plurality of network units. Some or all of the units can be selected according to actual demand, so as to implement the objectives of the solution in the embodiment.

Also, all function units in each embodiment of this disclosure can be integrated into one processing unit. Alternatively, each unit can physically exist alone. Alternatively, two or more units can be integrated into one unit. The above integrated unit can be implemented in a form of hardware or in a form of a software function unit.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

When implemented in the form of the software function unit and sold or used as an independent product, the integrated unit can be stored in a computer-readable storage medium. Based on such understanding, the technical solution of this disclosure essentially, the part contributing to the related art, or all or some of the technical solution can be embodied in a form of a software product. The computer software product is stored in one storage medium and includes several instructions configured for enabling one computer device (which can be a personal computer, a server, a network device, etc.) to execute all or some of the operations of the method in each embodiment of this disclosure. The foregoing storage medium includes: various media that can store program codes, such as a universal serial bus (USB) flash disk, a removable hard disk, a read-only memory (ROM), a random access memory (RAM), a magnetic disk, and an optical disk.

In conclusion, the above embodiments are merely configured for describing the technical solution of this disclosure, and are not intended to limit this disclosure. Although this disclosure is described in detail with reference to the foregoing embodiments, those of ordinary skill in the art is to understand that they can still make modifications to the technical solution described in each foregoing embodiment or make equivalent replacements to some technical features. These modifications or replacements do not cause the essence of the corresponding technical solution to depart from the spirit and scope of the technical solution in each embodiment of this disclosure.

What is claimed is:

1. A method of photographing control, the method comprising:
according to an image collection instruction, setting a lamp to an illumination mode, the lamp providing a supplemental light with a supplementation intensity exceeding a preset intensity threshold in the illumination mode;
adjusting a photographing mode of a camera from a fixed exposure mode to an automatic exposure mode, the automatic exposure mode using a fixed exposure parameter value of the fixed exposure mode as an initial exposure parameter value;
taking M shot images by the camera based on the automatic exposure mode with the initial exposure parameter value, M being an integer greater than or equal to 1; and
determining a target shot image from the M shot images, the target shot image having an image quality satisfying a preset image quality requirement.

2. The method according to claim 1, wherein:
the fixed exposure parameter value that is used in the fixed exposure mode is determined according to one or more historical exposure parameter values.

3. The method according to claim 2, further comprising:
acquiring an exposure parameter value used to take the target shot image; and
storing the exposure parameter value of the target shot image into a historical exposure parameter database, the historical exposure parameter database being configured to provide the one or more historical exposure parameter values for determining the fixed exposure parameter value.

4. The method according to claim 3, further comprising:
determining a distance value between a target object and the camera based on a measurement result of a distance sensor; and
executing the image collection instruction when the distance value between the target object and the camera is less than a distance threshold.

5. The method according to claim 4, further comprising:
controlling the camera in the fixed exposure mode as the photographing mode when the distance value between the target object and the camera is greater than or equal to the distance threshold.

6. The method according to claim 5, wherein the controlling comprises:
acquiring the fixed exposure parameter value; and
controlling the camera in the fixed exposure mode as the photographing mode according to the fixed exposure parameter value.

7. The method according to claim 6, wherein the acquiring comprises:
acquiring N historical exposure parameter values, the N historical exposure parameter values being exposure parameter values associated respectively with N shot images that respectively satisfy the preset image quality requirement, and N being an integer greater than or equal to 1; and
calculating the fixed exposure parameter value according to the N historical exposure parameter values.

8. The method according to claim 7, wherein:
the acquiring N historical exposure parameter values comprises:
acquiring N exposure times and N exposure gain values that are respectively associated with the N shot images; and
the calculating the fixed exposure parameter value comprises:
calculating a fixed exposure time according to the N exposure times, and
calculating a fixed exposure gain value according to the N exposure gain values.

9. The method according to claim 8, further comprising:
setting the lamp to a breathing lamp mode when the distance value between the target object and the camera is greater than or equal to the distance threshold.

10. The method according to claim 1, wherein the taking the M shot images comprises:
acquiring a current exposure amount and current environmental brightness;
determining a target exposure amount according to the current exposure amount and the current environmental brightness;
determining an exposure adjustment value according to the current exposure amount and the target exposure amount;
adjusting the current exposure amount to the target exposure amount according to the exposure adjustment value; and
taking the M shot images based on the target exposure amount.

11. The method according to claim 1, wherein the determining the target shot image from the M shot images comprises:
acquiring M resolution values respectively of the M shot images; and
determining, based on the M resolution values respectively of the M shot images, the target shot image with a resolution value greater than a preset resolution.

12. An apparatus, comprising processing circuitry configured to:
according to an image collection instruction, set a lamp to an illumination mode, the lamp being configured to provide a supplemental light with a supplementation intensity exceeding a preset intensity threshold in the illumination mode;
adjust a photographing mode of a camera from a fixed exposure mode to an automatic exposure mode, the automatic exposure mode using a fixed exposure parameter value of the fixed exposure mode as an initial exposure parameter value;
take M shot images by the camera based on the automatic exposure mode with the initial exposure parameter value, M being an integer greater than or equal to 1; and
determine a target shot image from the M shot images, the target shot image having an image quality satisfying a preset image quality requirement.

13. The apparatus according to claim 12, wherein:
the fixed exposure parameter value that is used in the fixed exposure mode is determined according to one or more historical exposure parameter values.

14. The apparatus according to claim 13, wherein the processing circuitry is configured to:
acquire an exposure parameter value used to take the target shot image; and
store the exposure parameter value of the target shot image into a historical exposure parameter database, the historical exposure parameter database being configured to provide the one or more historical exposure parameter values for determining the fixed exposure parameter value.

15. The apparatus according to claim 14, wherein the processing circuitry is configured to:
determine a distance value between a target object and the camera based on a measurement result of a distance sensor; and
execute the image collection instruction when the distance value between the target object and the camera is less than a distance threshold.

16. The apparatus according to claim 15, wherein the processing circuitry is configured to:
control the camera in the fixed exposure mode as the photographing mode when the distance value between the target object and the camera is greater than or equal to the distance threshold.

17. The apparatus according to claim 16, wherein the processing circuitry is configured to:
acquire the fixed exposure parameter value; and
control the camera in the fixed exposure mode as the photographing mode according to the fixed exposure parameter value.

18. The apparatus according to claim 17, wherein the processing circuitry is configured to:
acquire N historical exposure parameter values, the N historical exposure parameter values being exposure parameter values associated respectively with N shot images that respectively satisfy the preset image quality requirement, and N being an integer greater than or equal to 1; and
calculate the fixed exposure parameter value according to the N historical exposure parameter values.

19. The apparatus according to claim 18, wherein the processing circuitry is configured to:
acquire N exposure times and N exposure gain values that are respectively associated with the N shot images;
calculate a fixed exposure time according to the N exposure times; and
calculate a fixed exposure gain value according to the N exposure gain values.

20. A non-transitory computer-readable storage medium storing instructions which when executed by at least one processor cause the at least one processor to perform:
according to an image collection instruction, setting a lamp to an illumination mode, the lamp providing a supplemental light with a supplementation intensity exceeding a preset intensity threshold in the illumination mode;
adjusting a photographing mode of a camera from a fixed exposure mode to an automatic exposure mode, the automatic exposure mode using a fixed exposure parameter value of the fixed exposure mode as an initial exposure parameter value;
taking M shot images by the camera based on the automatic exposure mode with the initial exposure parameter value, M being an integer greater than or equal to 1; and
determining a target shot image from the M shot images, the target shot image having an image quality satisfying a preset image quality requirement.
